(19) United States
(12) Patent Application Publication
(10) Pub. No.: US 2008/0067816 A1
(43) Pub. Date: Mar. 20, 2008

(54) HIGH-UTILIZATION TURBINE FARMS WITH DIRECTLY DRIVEN GENERATORS AND FORCED-AIR COOLING

(76) Inventor: Traugott Garzmann, Braunschweig (DE)

Correspondence Address: GREENBLUM & BERNSTEIN, P.L.C., 1950 ROLAND CLARKE PLACE, RESTON, VA, 20191, US

(21) Appl. No.: 11/855,679

(22) Filed: Sep. 14, 2007

(30) Foreign Application Priority Data
Sep. 15, 2006 (DE) 10 2006 043 470.6

(51) Int. Cl. F03D 9/00

(52) U.S. Cl. 290/55

(57) ABSTRACT

In areas with strong winds on average, high-utilization wind farms have very high-energy yields per unit area and low installation costs compared with wind farms of standard turbines. The arrangement of four wind turbines at four different levels in a grid in an enclosed industrial area results in a quadruple energy yield. In addition, the increase in wind strength for rated operation to twice the average wind speed results in a further energy gain owing to better use of the high speeds. In addition, small directly-driven generators can have smaller pole pitches and make better use of the active material with forced-air cooling. For example in airs with strong winds, particularly on the coasts or on sea, hydrogen can already be electrolytically produced on site more cheaply, as regards the calorific value, than oil or natural gas. This will win acceptance of renewable energy in the hydrogen economy.

### CROSS-REFERENCE TO RELATED APPLICATIONS

The present application claims priority under 35 U.S.C. §119 of German Patent Application No. 10 2006 043 470.6, filed on Sep. 15, 2006, the disclosure of which is expressly incorporated by reference herein in its entirety.

### BACKGROUND OF THE INVENTION

1. Field of the Invention

The invention relates to a high-utilization turbine farms and, more particularly, the invention relates to a high-utilization turbine farms with directly driven generators and forced-air cooling.

2. Discussion of Background Information

Wind power stations must be resistant to storm gusts at speeds of 50 m/s or more. They are usually designed to have their rated power at a wind speed of 12.5 m/s; whereas at higher speeds they need to be adjusted to constant output or switched off.

### SUMMARY OF THE INVENTION

The invention improves apparatuses of the above-mentioned type. The listing power rating of wind turbines increases with the square of their diameter, whereas a corresponding increase in size is accompanied by a cubed increase in power rate. Small power stations therefore have less weight per unit output.

According to the invention, large turbines are replaced by small towers disposed in a grid at four hub levels. The horizontal distance between towers is equal to twice the raster spaces. The result, at the same tower spacing relative to the tower diameter, in the case of wind farms with high utilisation and small turbines at four hub levels, is a fourfold increase in output per unit area. This is compared with large turbines at only one level, since both the listing of the turbines and the area required for them increase with the square of the turbine diameter.

Small turbines with small light blades can be used to obtain higher peripheral speeds. For example, directly driven generators can be constructed with small pole pitches and air gaps, resulting in rated frequencies in the same range as conventional main frequencies. This results in high utilisation of the active material of the generators, which can be completely enclosed. To this end, the casing is constructed with a double jacket of sea-water resistant cast aluminium, through which the wind flows. A separate fan cools the field windings in an inner air circuit through cooling slots in the inner jacket. The resulting generator can be advantageously produced in large quantities, particularly for rough conditions at sea or on the coast. Since small turbines can provide higher peripheral speeds, they can make substantial use of the power of high-speed winds, which increases with the cube.

The rated power, during operation for electrolysis of water, is reached at about twice the average wind speed. High-utilization wind farms should be constructed only at places with average wind speeds above 8 m/s. In that case hydrogen can be produced more cheaply on site, relative to the calorific value, than when using natural gas or oil. Via pipelines, the hydrogen can then transport large amounts of energy with low loss over great distances. The generators deliver the current for electrolysis via rectifiers, without the need for complicated converters and circuits for connection to the power system. At the consumer centers, the energy of the hydrogen is reconverted with high efficiency to electricity in gas turbine steam power stations interlinked by cables. No additional high-voltage lines to large central power stations are required.

The optimum design of wind farms will depend on the dimensions of the available ground area, the main wind directions, the turbine diameter, the ratio of the tower spacing to the turbine diameter, the hub heights and the pitch angles of the turbines. Apart from the blade region, the turbine can be constructed in the form of lattice towers with tubular profiles and low aerodynamic drag and low consumption of material.

At sea in water up to about 30 meters deep, the wind farms can be built on quadropiles. These comprise four vertical tubes in a grid with gravity foundations, receiving the towers on crossheads. The towers are connected by horizontal support tubes and load-bearing tubes, on which the water turbines are suspended. The result is a firm stable frame. The complete installation can be prepared in port and towed to its planned site. In deeper water, the towers are mounted in a grid on a floating anchored tubular lattice which, in rough seas, can be lowered under the surface by the anchor windlasses, thus relieving the tubular lattice from severe stress by the wave troughs and peaks. These installations likewise can be prepared and maintained in port.

Meanwhile wind farms comprising large individual floating turbines with a power of 2 MW are to be built in the Baltic Sea at Rügen. A comparison will show the advantages of high-utilisation wind farms in areas with strong winds. In the standard design, a 2 MW turbine has a diameter of 75 m. If the ratio of the tower spacing to the turbine diameter is 5, the tower spacing will be 375 m and the area required will be 375×375 m²=140625 m². This corresponds to a rated power density of 14.2 W/m². Small turbines will give four times this value. Standard turbines with rated power, are uneconomical, however, at 12.5 m/s. They are profitable only when the operators are subsidized. In high-utilization wind farms on the other hand, at an average wind speed of 10 m/s the rated wind speed is 20 m/s and the rated power density is 16 times as high, so that hydrogen can be economically generated by electrolysis. Large standard turbines are not only uneconomic but also take up unnecessary space which could be better used by wind farms at high wind speeds.

The diameter of small turbines can be about 15 to 25 m. Large turbines have a few relatively heavy components; whereas, small turbines have a larger number of lighter components for the same total output. In the case of wind farms on land, these self-contained industrial areas can be additionally used by commerce. Owing to the short tower spacing between small turbines, the distances between the wind farms have to be larger, so that the wind can collect again. Housing estates can therefore be built here without suffering from noise or overshadowing. In wind farms with large standard turbines, on the other hand, the entire farm land is converted into an industrial area, which is meeting increasing resistance from residents, also on account of the required subsidies.

In areas with low wind speeds, approval should be given only to those wind power stations which require no subsidies and do not place an appreciable burden on power installations and electricity systems.

In another aspect of the invention, a high-utility turbine farm and directly driven generators with forced-air cooling comprises turbines arranged in a grid at four levels one above the other. A distance between towers supporting the turbines is twice a grid space. A rated power of the generators is reached at about double an average wind speed. The turbine farm is located in water disposed on quadropiles at the grid spacing. The turbine farm is disposed in a grid on a floating tubular lattice anchored in water and configured to be pulled under a surface of the water. The quadropiles are four vertical tubes in a grid with gravity foundations receiving towers on crossheads and the turbines are water turbines. The towers are connected by horizontal support tubes and load-bearing tubes, on which the water turbines are suspended. The turbines are four wind turbines at four hub levels. The casing of the turbines is constructed with a double jacket of sea-water resistant cast aluminium. There are separate fans which cool windings in an inner air circuit through cooling slots in an inner jacket of the turbines. The turbines have a diameter of about 15 to 25 m. The turbines are four wind turbines. Two wind turbines are provided one above another and another two wind turbines are provided one above another. The turbines produce an operating current which is used to produce hydrogen via electrolysis. A compressor is configured to compress hydrogen for transportation via pipeline.

In another aspect of the invention, a high-utility turbine farm comprises wind turbines arranged on towers in a grid at four different hub levels. A distance between the towers is twice a grid space. The wind turbine farm further comprises directly driven generators with forced-air cooling. A rated power of the generators is reached at about double an average wind speed. The turbine farm is located in water disposed on quadropiles at the grid spacing. The wind turbine farm is disposed in a grid on a floating tubular lattice anchored in water and configured to be pulled under a surface of the water. The wind turbines are four wind turbines. The wind turbines have a diameter of about 15 to 25 m.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a diagrammatic plan view of wind power stations in accordance with the invention;

FIG. 2 shows a diagrammatic view of the installations in a grid in accordance with the invention;

FIG. 3 shows a turbine farm using quadropiles in accordance with the invention; and

FIG. 4 shows a turbine farm on floating anchored tubular lattice in accordance with the invention.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

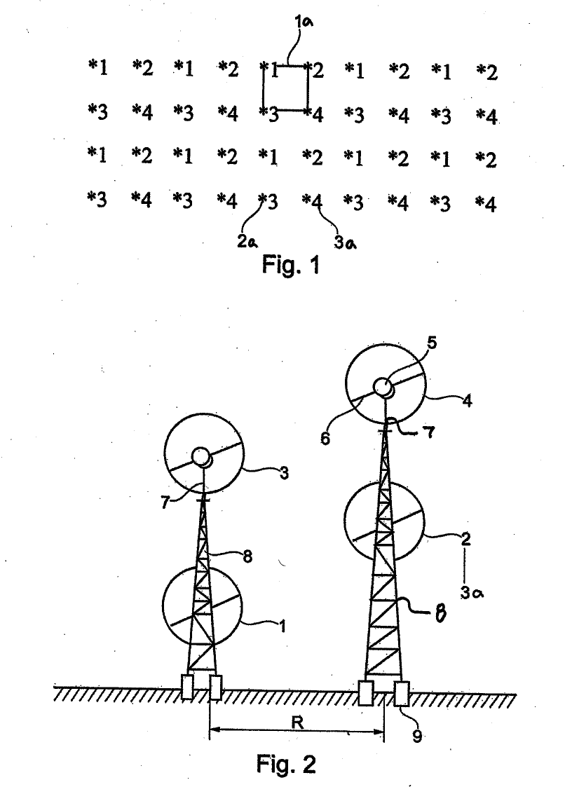

FIG. 1 shows a diagrammatic plan view of wind power stations in accordance with the invention. In particular, FIG. 1 shows a plurality of wind turbines 1-4 formed in a grid pattern 1a. That is, the wind turbines have a grid spacing as represented by reference numeral 1a. Reference numeral 2a represents a tower holding the wind turbines 1-4 and reference numeral 3a represents the vertical position of the wind turbines 1-4, each of which in embodiments will be at a different height for each grid as shown in FIG. 2, for example.

FIG. 2 shows a diagrammatic view of the installation of wind turbines in a grid in accordance with the invention. As shown in FIG. 2, wind turbine 1 is at a first height on round-steel lattice tower 8 and wind turbine 3 is at a different height on steel-tube tower 7, extending above the round-steel lattice tower 8. Similarly, wind turbine 2 is at a first height on round-steel lattice tower 8 and wind turbine 4 is at a different height on heights on a steel-tube tower 7, extending above the round-steel lattice tower 8. Thus, as shown, each of the wind turbines 1-4, in a grid, is at a different height (four hub levels). The tower supporting wind turbines 1 and 3 and the tower supporting wind turbines 2 and 4 are spaced apart by grid dimension “R”. In embodiments, the horizontal distance “R” between towers is equal to twice the raster spaces.

Also, as shown in FIG. 2, each of the round-steel lattice towers 8 is supported on a foundation 9. Additionally, each of the wind turbines 1-4 includes a wind turbine, generator and pod 5, in addition to turbine blades 6. The diameter of turbine blades can be about 15 to 25 m.

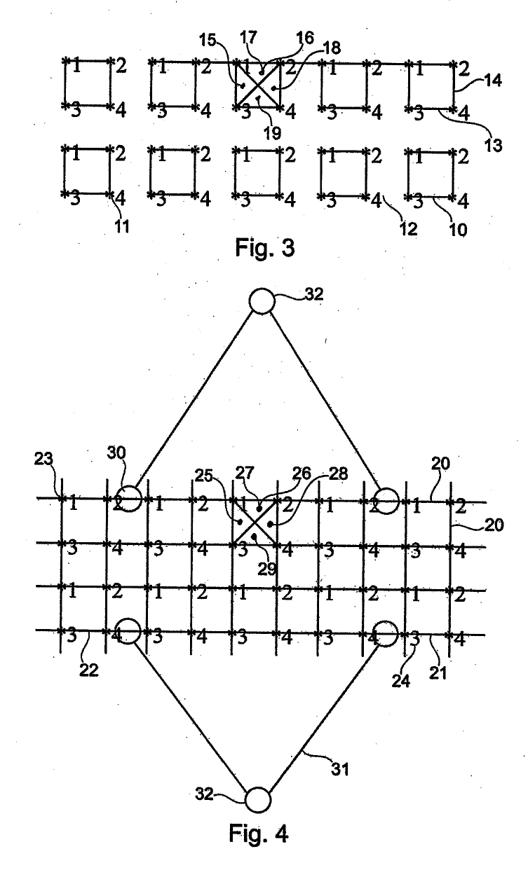

FIG. 3 shows a wind farm using quadropiles in accordance with the invention. More specifically, reference numeral 10 represents quadropiles in the grid using wind turbines 1-4. Reference numeral 12 represents the vertical position of wind turbines 1-4, for each of the wind turbines 1-4. As discussed above, each wind turbine 1-4 in the grid has a different hub height.

In the configuration of FIG. 3, reference numeral 11 diagrammatically represents the tower with the turbine, crosshead and vertical tube. The towers are connected by horizontal support tubes 14 and load-bearing tubes 13, on which water turbines are suspended. As shown in FIG. 3, the load bearing tubes 13 are provided between adjacent turbines 3 and 4, for example, and support tubes 14 are provided between turbines 2 and 4. Of course other configurations are also contemplated by the invention such as, for example, the load bearing tubes 13 provided between adjacent wind turbines 1 and 2, for example, and support tubes 14 provided between wind turbines 1 and 3.

As further shown in FIG. 3, the turbines produce an operating current 19, which can be used to produce hydrogen via electrolysis as represented by reference numeral 15. A compressor 16, shown diagrammatically, is provided for the turbines 1-4. The compressor 16 can compress the hydrogen for transportation via the pipeline 17. Hydrogen, a storable energy carrier, can thus convert an irregular wind with low market value into a valuable fuel without carbon dioxide emission and transportable over entire continents with acceptable losses and costs. Reference numeral 18 represents sea-water desalination which can be produced by electrodialysis, where the required electricity is provided by the wind turbines.

FIG. 4 shows a turbine farm on floating anchored tubular lattices in accordance with the invention. In this diagrammatic view, the grid spacing is represented by reference numeral 20. The turbines can be mounted on a tubular lattice 21. The turbines are supported on a crosshead and tower represented by reference numeral 23, connected together by connecting flanges 22. An anchor chain 31 connects an anchor 32 to an anchor winch 30. The anchor 32, anchor chain 31 and anchor winch 30 are designed to stabilize the turbines 1-4. In embodiments, a plurality of anchors 32, anchor chains 31 and anchor winches 30 are contemplated by the invention, depending on the number of turbines in the farm. Reference numeral 24 represents the vertical position (storey) of turbines 1-4, as discussed herein. The farm is of FIG. 4 is thus disposed in a grid on a floating tubular lattice anchored in water and configured to be pulled under a surface of the water for use as water turbines.

As discussed with reference to FIG. 3, in FIG. 4 the turbines produce an operating current 29. The operating current can be used to produce hydrogen via electrolysis as represented at reference numeral 25. A compressor 26 is shown diagrammatically for the wind turbines 1-4. The compressor can compress the hydrogen for transportation via the pipeline 27. Hydrogen, a storable energy carrier, can thus convert an irregular wind with low market value into a valuable fuel without carbon dioxide emission and transportable over entire continents with acceptable losses and costs. Reference numeral 28 represents sea-water desalination which can be produced by electrodialysis, where the required electricity is provided by the wind turbines.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular materials and embodiments, the present invention is not intended to be limited to the particulars disclosed herein; rather, the present invention extends to all functionally equivalent structures, methods and uses, such as are within the scope of the claims.

1-20. (canceled)

21: High-utility wind farms and directly driven generators with forced-air cooling, characterised in that the wind turbines are arranged in a grid at four levels one above the other, wherein the distance between towers is twice the grid space.

22: Wind farms according to claim 21, characterised in that the rated power of the generator is reached at about double the average wind speed.

23: Wind farms according to claims 21 and 22, characterised in that the wind farms in the sea are disposed on quadropiles at the grid spacing.

24: Wind farms according to claims 21 and 22, characterised in that the wind farms are disposed in a grid on a floating tubular lattice anchored in the sea and adapted to be pulled under the surface of the water in rough seas.
